(19) United States
(12) Patent Application Publication
(10) Pub. No.: US 2023/0405745 A1
(43) Pub. Date: Dec. 21, 2023

(54) APPARATUS FOR CENTERING, GUIDING AND ADVANCING BARS TO BE FED TO MACHINE TOOLS

(71) Applicant: CUCCHI GIOVANNI & C. S.r.l., Bussero (IT)

(72) Inventor: Cesare Cucchi, Bussero (IT)

(21) Appl. No.: 18/247,533

(22) PCT Filed: Sep. 29, 2021
(86) PCT No.: PCT/IB2021/058920

§ 371 Date: Mar. 31, 2023

(30) Foreign Application Priority Data
Oct. 1, 2020 (IT) 102020000023326

(51) Int. Cl. B23Q 1/76; B23B 13/12; B23B 13/08

(52) U.S. Cl. CPC B23Q 1/763; B23B 13/126; B23B 2270/12; B23B 13/08; B23B 13/123

(57) ABSTRACT

An apparatus includes a self-centring device for centring and guiding a bar, tube or the like to be advanced to a spindle of a machine tool, includes a hollow containing body with through opening having a longitudinal axis, for receiving a bar to be fed along an advancement direction to the spindle; in the body an inner sliding surface is defined that is tilted with respect to the longitudinal axis; centring and guiding elements are provided housed in the hollow body and shaped for coming into contact with the bar and exert thereupon a distributed centring and guiding action; the centring and guiding elements that are slidable along the inner surface for the distance thereof from the longitudinal axis to adapt to different bar diameters; in the body an elastic member is housed to urge the centring and guiding elements to the position of minimal reciprocal distance so as to induce and maintain, during operation, the centring and guiding elements in contact with the surface of the bar. An advancement device is further disclosed for the bar, having a supporting and guiding member configured for restingly receiving, from a first side, a bar and configured for guiding said bar along an advancement direction, a movable grasping member mobile from a disengaged position, further from the member to be separated from the bar, to a locking position, nearer said supporting member to press longitudinally the bar from a second opposite side against the supporting member; advancement motor device is configured for rotating the supporting and guiding member and/or the movable grasping member in the locking position to draggingly advance the bar along the advancement direction.

The present invention relates to an apparatus for advancing, centring and guiding a bar to be fed to a machine tool spindle, maintaining the aforesaid bar in an axially correct position.

### BACKGROUND OF THE INVENTION

For machining a bar, tube, or in general an oblong metal piece, using a feeding and guiding apparatus is known the function of which is to advance the aforesaid bar to a machine tool, in particular a lathe of the single-spindle or multiple-spindle type.

The feeding apparatus includes an advancement device for advancing the bar, generally a pusher or bar pusher, configured for exerting a pushing action on the rear end of the bar to be fed. A bar pusher of known type is described in ITMI20091964.

The feeding apparatus can further include a centring device the function of which is to attempt to reduce the oscillations to which the aforesaid bar is subjected and to maintain the bar in a correct axial position.

Some centring devices are known from EP0213659 and EP0485902 in the name of the present applicant, and yet others are known from DE102014100788, GB1342133, DE29500846 and WO2017/149446.

Currently, machine tools such as lathes operate at very high rotation speeds, which can reach values of the order of ten thousand revolutions per minute or even more. Accordingly, in consideration of such high operating regimes, it is necessary to ensure precise axial positioning and precise advancement of the bar to be machined, reducing to a maximum the oscillations to which the bar is subjected to avoid damage to the apparatus and to avoid machining errors.

Current advancement devices and centring devices are not particularly effective in their advancement and guiding action and do not perform a satisfactory action of maintenance of the bars in the perfectly aligned axial position.

The difficulty is accentuated by the fact that the bars, in addition to advancing axially, are also rotated around the longitudinal axis thereof.

When the bars to be processed are very slim, i.e. they have very reduced sections, they are very subject to shape instability phenomena, i.e. they have a great tendency to flex through small eccentricities and inertia during rotation, causing shocks and stress in this motion that are also harmful to the apparatus.

Current bar pusher devices are thus hardly effective in the advancement action as the pushing actions thereof exerted on the rear end of the bar do not at all facilitate containment of the phenomena of flexure or swinging of the bar, consequently making the action of guiding and positioning current centring devices more difficult so that they often turn out to be unsuitable.

An increase of the diameter of the bars is not matched by a reduction of the aforesaid instability and flexure phenomena because an equal increase of the rotation speeds of the bar again causes the aforementioned problems of oscillation or knocking or shocks.

Another limit of current devices is the great structural and functional complexity thereof, which is also reflected in a greater financial cost and unsatisfactory mechanical reliability.

Another embodiment of centring device is known from EP0689890, in the name of the same applicant. This device includes an idling rotating annular guide element that is angularly orientable with respect to the bar.

The annular guide element is pushed to adhere to the bar at diametrically opposite points, orienting the bar by suitable actuators, and is rotated, exerting a dynamic centring action on the bar.

A similar centring device enables the problems of wear and noise caused by the knocking of the bars to be substantially reduced owing to the dynamic centring action on the bar; nevertheless, this centring device has rather a complex structure and requires a connection to a supply source that is suitable for allowing the operation of the actuators of the device.

It is clear that this solution, in addition to being rather complex structurally, it also operationally inconvenient because it requires an operator to intervene to adjust each time the angular orientation of the annular guide element according to the diameter of the bars to be centred.

Also centring devices are present that provide elastic blades fixed in a cantilevered manner to an annular support body; although such devices have quite a simple structural configuration, they are not able to satisfactorily remedy the problem of noise, surface damage to the bars, and in addition do not permit suitable adjustment of the pressure force with which the blades act on the bar being fed.

In the light of what has been described above, it is clear that there is ample room for improvement of current bar-centring systems.

### SUMMARY OF THE INVENTION

The main object of the present invention is to remedy the limits inherent in known centring systems.

Another object is to provide an apparatus that is at the same time structurally and functionally simple, effective and reliable, which is able to reduce significantly, owing the damping action, the noise and the risk of surface damage to the advancing bars.

In particular, the intention is to provide a self-centring device that is able to guide and to center bars of various diameter without the need to make adjustments to the device, also enabling bars having very reduced diameters to be centred.

A further object of the present invention is to provide a self-centring device that is easy to fit to any already existing bar-feeding apparatus, with clear advantages in terms of cost and assembly times.

A still further object is to provide an apparatus that is constructionally cheap but highly performing that is able to advance the bars with more facility in an optimum manner, ensuring the correct positioning thereof and reducing significantly the oscillation and swinging phenomena to which the bars are subjected during advancement.

The above can be achieved by the solution as defined in the enclosed claims.

Owing to the solution according to the invention, all the above objects are achieved.

### BRIEF DESCRIPTION OF THE DRAWINGS

These and further features according to the present invention will be clearer from the following description with reference to the attached drawings, in which:

FIG. 1 is a longitudinal section view of part of an apparatus that includes a self-centring device for bars according to the present invention;

FIGS. 2 and 3 are two different perspective views of the self-centring device according to the present invention;

FIG. 4 is an exploded view of the self-centring device according to the present invention;

FIG. 5 is a frontal view of the self-centring device according to the present invention;

FIG. 6 is a longitudinal section taken along the plane VI-VI in FIG. 5;

FIG. 7 is a longitudinal section of the self-centring device in operation, in which a bar of reduced section is shown;

FIG. 8 shows the self-centring device in an operating condition before receiving a bar having a greater section than the case shown in FIG. 7;

FIG. 9 shows the self-centring device coupled with the bar to be fed shown in FIG. 8;

FIGS. 10 and 11 show an advancement device included in the apparatus according to the invention respectively in two different operating positions.

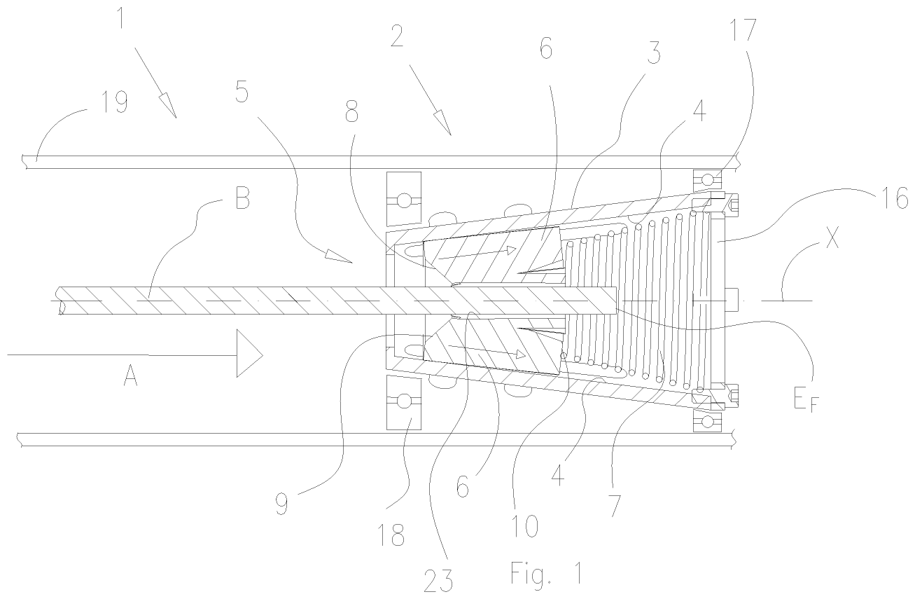

### DETAILED DESCRIPTION OF THE INVENTION

With reference to the attached Figures, an apparatus 1 is shown for centring, guiding and advancing bars B (or tubes or other oblong metal elements) intended to be supplied to a machine tool, in particular to a lathe that can be of the single-spindle or multi-spindle type. The apparatus 1 includes a self-centring device 2 for centring and guiding a bar B to be advanced to a spindle of a lathe.

The self-centring device 2 according to the invention is configured for guiding and maintaining the bars or tubes aligned on the work axis of the machine tool, adapting to bars or tubes of different diameter.

For the purposes of the present description, the term “bar” means any elongated linear element, of circular or polygonal, full or tubular section.

The self-centring device 2 includes a hollow containing body 3 that extends along a longitudinal axis X. In the containing body 3 a through opening 5 is defined—extending along the aforesaid longitudinal axis X—suitable for being traversed by the bar B to be fed along an advancement direction A to a spindle of the lathe, or anyway to the machine tool.

The containing body 3, in particular, has a frustoconical shape and is couplable with a tubular element 19 of the feeding apparatus.

The self-centring device 2, if desired, can also be fitted to a part of the lathe. In this case, the containing body 3 will be suitably connected to a tubular portion of the aforesaid lathe.

In the hollow containing body 3, an inner sliding surface 4 is defined that is tilted with respect to the aforesaid longitudinal axis X; precisely, the inner sliding surface 4 is divergent in the advancement direction of the bar B, i.e. according to the advancement direction A.

Inside the hollow containing body 3, a plurality of centring and guiding elements 6 is housed, shaped for interacting, i.e. coming into contact, with the bar B and for exerting a distributed centring and guiding action around the bar B.

The centring and guiding elements 6 can be any desired number, for example, three or more, according to specific needs and in function of the sizing of the self-centring device 2. The centring and guiding elements 6 are circularly and evenly distributed around the longitudinal axis X.

The centring and guiding elements 6 are movable slidably along the inner sliding surface 4 so as to vary the distance thereof from the longitudinal axis X to adapt to various possible bar diameters B.

The centring and guiding elements 6 are movable from a position of minimal reciprocal distance to a position of maximum reciprocal distance, to adapt to different possible diameters of the bar.

The self-centring device 2 further includes retaining and guiding members (11,12,13,14) for the centring and guiding elements 6.

The retaining and guiding members include, for each centring and guiding element 6, a sliding slot 11 obtained along the wall of the containing body 3 and screw elements 12 engaging in holes 22 obtained on a respective centring and guiding element 6 and slidable along the respective sliding slot 11.

Each screw element 12 is shaped with a stem 14, that is slidable along the respective sliding slot 11, and with a head 13 shaped for maintaining the centring and guiding element 6 coupled with the containing body 3 to prevent reciprocal separation thereof.

The self-centring device 2 includes an elastic member 7 configured for urging the centring and guiding elements 6 to the position of minimal reciprocal distance so as to induce and maintain, during operation, the aforesaid centring and guiding elements 6 in contact with the surface of said bar B. In other words, the elastic member 7 ensures that the centring and guiding elements 6 are always clamped around the bar, so as to keep the bar in the correct position.

The elastic member, more precisely, includes a helical spring 7 having a base end 15 in a position that is stationary with respect to the containing body 3, and a movable pushing end 20 in contact with the centring and guiding elements 6.

The helical spring 7 extends around the longitudinal axis X and has coils of progressively decreasing diameter in the direction that goes from the base end 15 to the movable pushing end 16.

Each centring and guiding element 6 has a front end portion 8 that is suitable for intercepting a front end E_{F} of the bar B.

On the front end portion 8 a tilted promoting surface 9 is defined that eases the penetration of the bar B into the containing body 3.

The tilted promoting surface 9 is shaped for receiving a push from the front end E_{F} of the bar B intended to move the respective centring and guiding element 6 along the inner sliding surface 4.

The centring and guiding elements 6 have respective rear end portions 10 on which the aforesaid elastic member 7 act to push the centring and guiding elements 6 against the bar B.

An annular flange 16 is further provided to retain the helical spring 7 inside the containing body 3.

The annular flange 16 has a surface configured for being fixed to a wider end of the containing body 3 and for restingly receiving the base end 15 of the helical spring 7.

Bearing elements 17, 18 are further provided that are fitted around the containing body 3 and suitable for enabling the containing body 3 to be rotatably coupled and housed inside a portion of a tubular element 19 of a feeding apparatus or machine tool, inside which the bars to be machined can advance.

The operation of the self-centring device 2 is now disclosed briefly.

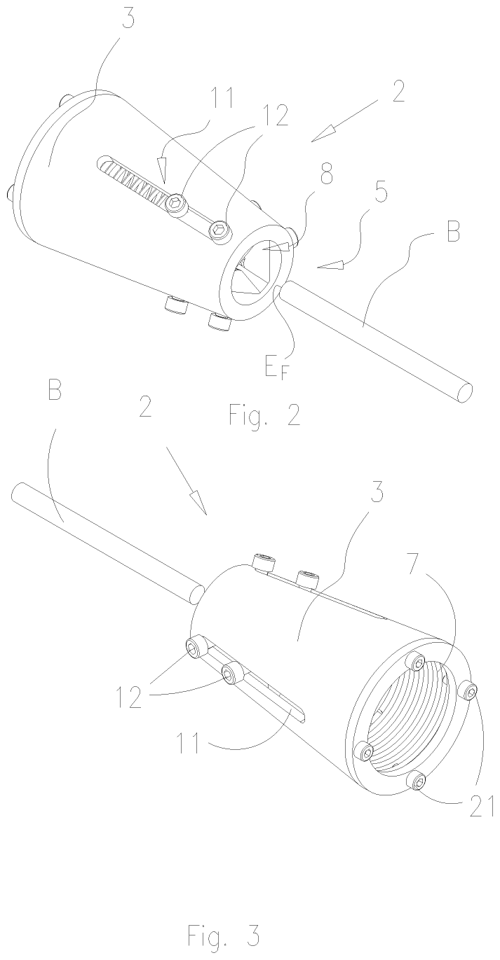

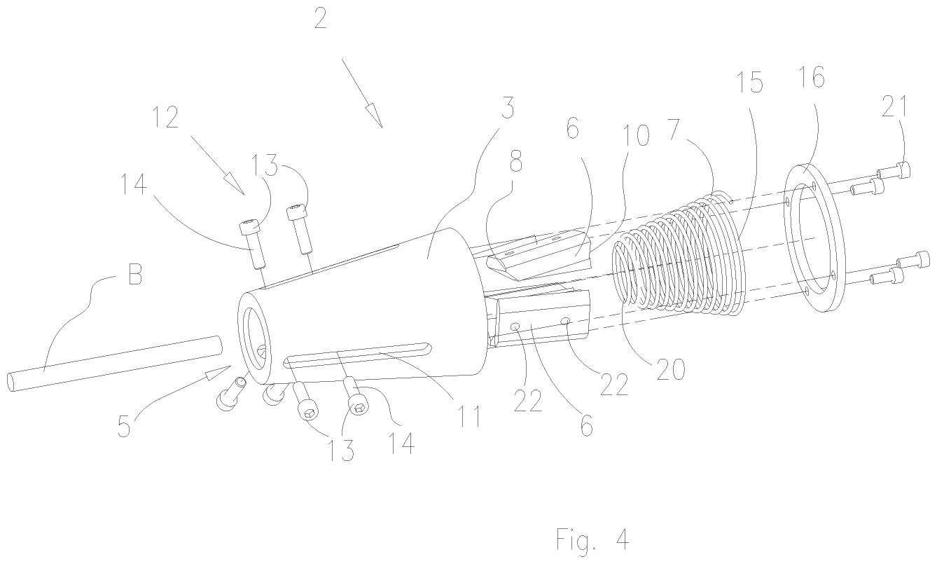

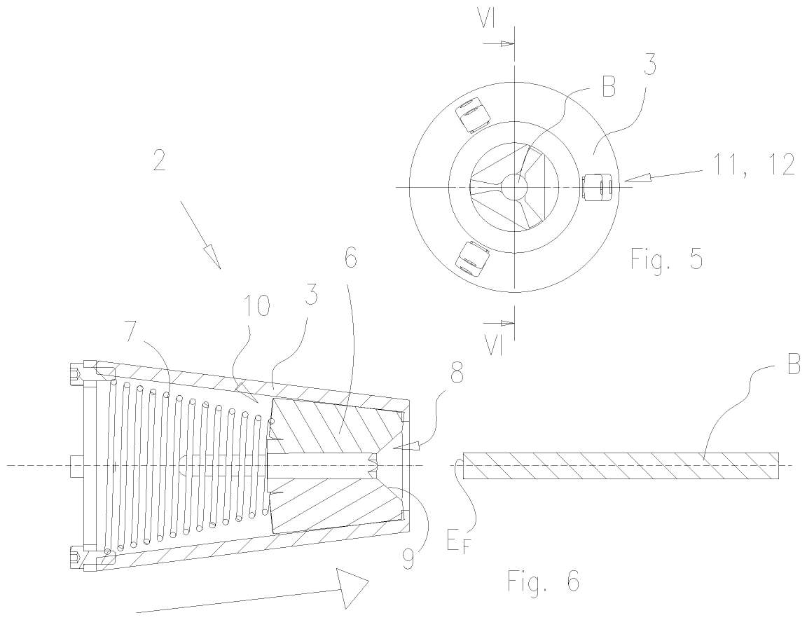

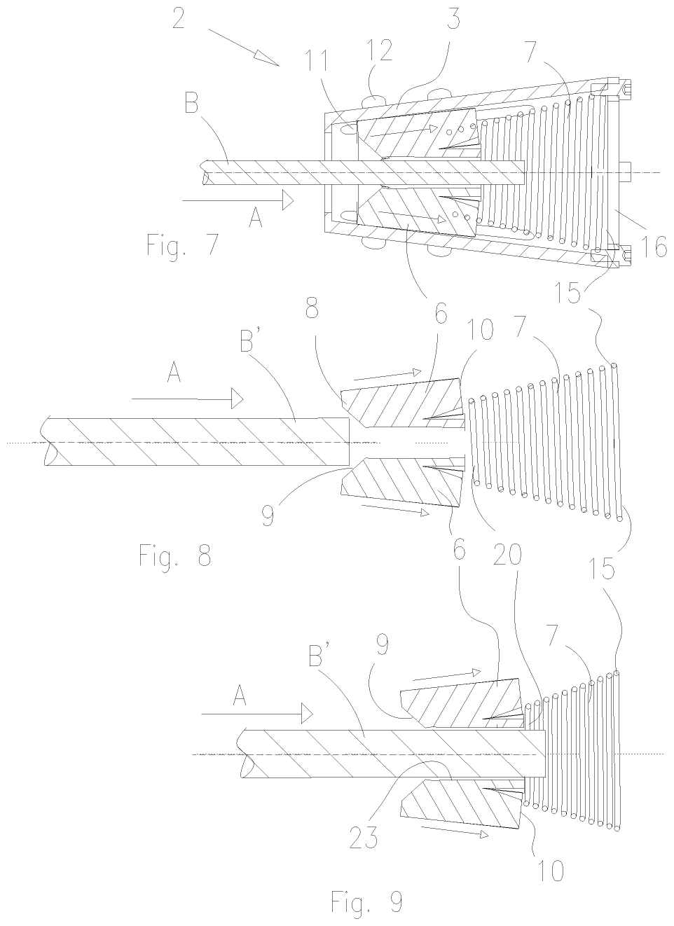

In a rest condition, shown for example in FIGS. 2, 3, 6, the device 2 is ready for receiving a bar. The centring and guiding elements 6, through the effect of the push of the spring 7, are placed in a mutually nearer position.

The tilted surfaces 9 are ready to receive and come into contact with the front end E_{F} of a bar B.

When the bar B comes into contact with the end portions 8 of the centring and guiding elements 6, the bar B exerts on the latter a push that causes movement thereof and reciprocal spacing apart in a radial direction; in other words, the centring and guiding elements 6 include the helical spring 7 and diverge from one another by sliding along the inner surface 4 of the containing body 3 until the position is reached corresponding to the diameter of the bar B penetrating the containing body 3.

The correct and precise movement of the centring and guiding elements 6 is assured by the screw elements 12 cooperating with, and sliding along, the sliding slots 11.

The tilted surfaces 9 ease the coupling between the bar B and the centring and guiding elements 6. Once the bar B has penetrated between the centring and guiding elements 6, the spring 7 works by maintaining the abutting surfaces 23 of the centring and guiding elements 6 resting on the cylindrical side surface of the bar B.

FIGS. 8 and 9 show the operation of the self-centring device 2 in the case of a bar B′ of greater diameter.

Owing to the particular structural configuration, the centring and guiding elements 6 adapt independently to any diameter of the bar B, without the need for any outside intervention.

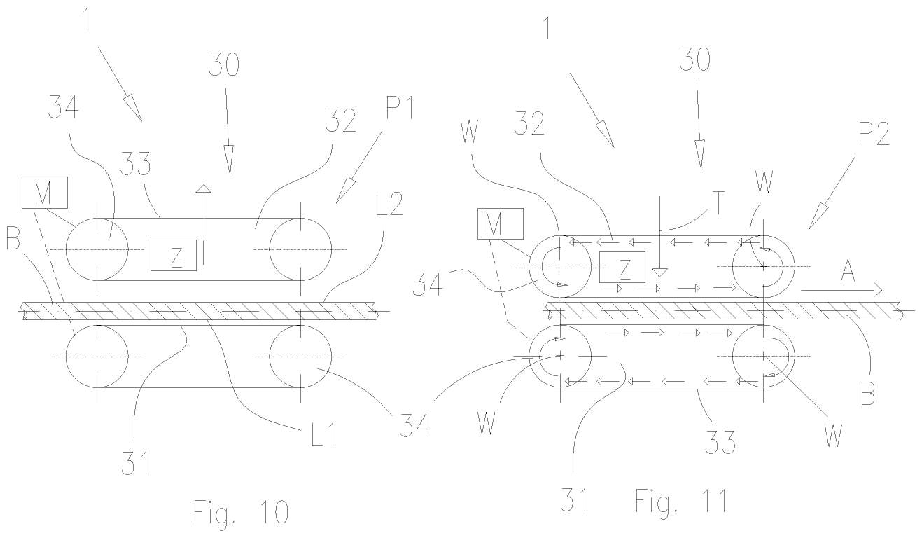

With particular reference to FIGS. 10 and 11, the apparatus 1 includes an advancement device 30 for the bars B, tubes or the like.

The advancement device 30 includes a supporting and guiding member 31 configured for restingly receiving, on a first side L1, a bar B and configured for guiding the bar B along the advancement direction A.

The advancement device 30 includes a movable grasping member 32 that is movable by a movement member Z, along an advancement direction T transversely to the advancement direction A.

The grasping member 32 is movable from a disengaged position P1, in which it is further from the supporting and guiding member 31 so as to be separated the bar B, to a locking position P2, in which the grasping member 32 is nearer the supporting member 31 to press longitudinally the bar B from a second side L2 opposite the first side L1 and against the supporting member 31.

The advancement device 30 includes an advancement motor device M configured for rotating the supporting and guiding member 31 and/or the movable grasping member 32 in the locking position P2 to drag and advance the bar B along the advancement direction A.

The motor device in particular includes an electric motor of brushless type.

The supporting and guiding member 31 and/or the grasping member 32 include a belt or tape element 33 that is wound around a pair of wheel elements 34 included in the advancement device 30.

The wheel elements 34 are spaced and rotatable around respective axes W arranged transversely to the advancement direction A.

The belt or tape element 33 is shaped for coming into contact with the side surface of the bar B to exert thereupon the action of dragging along the advancement direction A.

During operation, when the grasping member 32 is in the disengaged position P1, a bar B having any diameter can come to rest on the supporting and guiding member 31.

The movement member Z can bring the grasping member 32 up to the supporting and guiding member 31 until the locking position P2 is reached in which the bar B is grasped and clamped between the two members 31 and 32.

The motor M can then be driven to rotate the movable grasping member 32 and/or the support member 31, to advance the bar B as the arrows indicated in FIG. 11 show.

From what has been said and shown in the attached drawings, it is clear that the solution according to the invention achieves all the set objects.

In particular, the self-centring device 2 according to the invention is at the same time structurally simple and functionally effective and reliable, able to noticeably reduce, owing to the damping action performed by the oblong centring elements, the noise and the risk of surface damage to the advancing bars B.

The centring device according to the invention, of the passive type, is operationally and constructionally economical, being also very versatile; the centring device adapts automatically with efficacy to bars of various diameter, also very reduced, without the need to make adjustments on the device itself.

In particular, the static centring action supplied by the self-centring device 2 according to the invention is more effective in contrasting the great stress to which the bar B being supplied to the machine tool is subjected.

The effective guiding and centring action avoids knocking of the bar B, prevents any risk of surface damage to the latter and reduces wear and noise during feeding of the bar B. The self-centring device 2 according to the invention is easy to fit to any already existing bar-feeding apparatus, with clear advantages in terms of assembly cost and time.

The advancement device 30 included in the apparatus 1 according to the invention is further highly performing despite being constructionally economical; it is able to advance with great facility and in an optimized manner the bars B, ensuring the correct positioning thereof effectively and significantly reducing oscillation and swinging phenomena to which the bars are subjected during advancement: this is possible owing to the bilateral grasping action and distributed longitudinally along the cylindrical surface of the bar B, differently from the usual bar pushers that on the other hand, by acting on only the rear end of the bar, are not able to contain swinging phenomena.

Accordingly, the advancement device 30 included in the apparatus 1 according to the invention is significantly more effective in advancing, guiding and maintaining the bars B in the perfectly aligned axial position.

It is understood that what has been said and shown with reference to the attached drawings has been provided merely by way of illustration of the general features of the apparatus 1; so other modifications or variants can be made to the device or to parts thereof without thereby falling outside the scope of the claims.

In particular, the geometric conformation, dimensions and materials that make up one or more parts of the apparatus 1, in particular the self-centring device 2 and the advancement device 30, can be chosen and/or optimized appropriately on the basis of specific use requirements.

1. Self-centring device for centring and guiding a bar, tube or the like to be advanced to a spindle of a machine tool, including:
a hollow containing body with a through opening extending along a longitudinal axis and suitable for receiving and being traversed by a bar to be fed along an advancement direction to said spindle,
in said hollow containing body an inner sliding surface being defined that is tilted with respect to a said longitudinal axis,
a plurality of centring and guiding elements housed in said hollow containing body and shaped for coming into contact with said bar and exerting a centring and guiding action distributed around said bar,
said centring and guiding elements being slidably movable along said inner sliding surface so as to vary the distance thereof from said longitudinal axis to adapt to various possible bar diameters,
said centring and guiding elements being movable from a position of minimal reciprocal distance to a position of maximum reciprocal distance, to adapt to various possible bar diameters,
an elastic member configured for urging said centring and guiding elements to said position of minimal reciprocal distance so as to induce and maintain, during operation, said centring and guiding elements in contact with the surface of said bar,
said centring and guiding elements being provided with respective rear end portions on which said elastic member acts to push said centring and guiding elements against said bar.

2. Self-centring device according to claim 1, wherein each of said centring and guiding elements has a front end portion that is suitable for intercepting a front end of the bar, on said front end portion a tilted promoting surface being defined to promote penetration of the bar in said containing body, said tilted promoting body being shaped for receiving a push from said front end of the bar intended to move the respective centring and guiding element along said inner sliding surface.

3. Self-centring device according to claim 1, wherein said containing body has a frustoconical shape, and in which said inner surface is divergent according to said advancement direction.

4. Self-centring device according to claim 1, further including retaining and guiding members for said centring and guiding elements.

5. Self-centring device according to claim 4, wherein said retaining and guiding members include, for each centring and guiding element, a sliding slot obtained along a wall of said containing body and screw elements engaging a respective centring and guiding element and slidable along a sliding slot, each screw element being shaped with a stem, that is slidable along the respective sliding slot, and with a head shaped for maintaining the element centring and guiding element coupled with said containing body preventing reciprocal separation thereof.

6. Self-centring device according to claim 1, wherein said elastic member includes a helical spring with a base end in a position that is stationary with respect to said containing body, and a movable pushing end in contact with said centring and guiding elements, said helical spring extending around said longitudinal axis with coils of progressively decreasing diameter from said base end to said movable pushing end.

7. Self-centring device according to claim 6, further including an annular flange for retaining said helical spring inside said containing body, said annular flange having a surface configured for being fixed to an end of said containing body and for restingly receiving said base end of said helical spring.

8. Self-centring device according to claim 1, further including bearing elements fitted around said containing body and suitable for enabling said containing body to be housed rotatably inside a tubular element, of a feeding apparatus or machine tool, for advancing the bars.

9. Advancement device for a bar tube or the like, including:
a supporting and guiding member configured for restingly receiving, from a first side, a bar and configured for guiding said bar along an advancement direction,
a movable grasping member that is movable along an advancement direction transversely to said advancement direction, from a disengaged position, in which said movable grasping member is further from said supporting and guiding member so as to be separated from said bar, to a locking position, in which said movable grasping member is nearer said supporting member to press longitudinally said bar from a second side opposite said first side and against said supporting member,
an advancement motor device configured for rotating said supporting and guiding member and/or said movable grasping member in said locking position to drag and advance said bar along said advancement direction.

10. Advancement device according to the preceding claim, wherein said supporting and guiding member and/or said movable grasping member includes a belt or tape element that is wound around a pair of wheels that are spaced and rotatable around respective axes arranged transversely to said advancement direction, said belt or tape element being shaped for coming into contact with the side surface of said bar to perform thereupon the action of dragging along said advancement direction.

11. Advancement device according to claim 9, wherein said advancement motor device includes an electric motor of brushless type, and in which a movement member is further provided for translating said movable grasping member from said disengaged position to said locking position.

12. Apparatus for feeding a bar to a machine tool spindle, including a self-centring device according to claim 1 an advancement device according to claim 9.

13. Apparatus for feeding a bar to a machine tool spindle including an advancement device according to claim 9.
